(19) United States
(12) Patent Application Publication
(10) Pub. No.: US 2025/0133357 A1
(43) Pub. Date: Apr. 24, 2025

(54) TACTILE PUSH BUTTON WITH INTEGRATED CHARGE INTERFACE FOR HEARING INSTRUMENTS

(71) Applicant: Starkey Laboratories, Inc., Eden Prairie, MN (US)

(72) Inventor: Joseph Matthias Reis, JR., Minneapolis, MN (US)

(21) Appl. No.: 18/904,041

(22) Filed: Oct. 1, 2024

Related U.S. Application Data
(60) Provisional application No. 63/591,982, filed on Oct. 20, 2023.

(51) Int. Cl. H04R 25/00

(52) U.S. Cl. CPC H04R 25/602; H04R 25/603; H04R 25/65; H04R 2225/31

(57) ABSTRACT

A hearing instrument comprising: a rechargeable battery; a faceplate defining an aperture; a push button assembly coupled to the faceplate, wherein the push button assembly includes charging contacts, a button cover, and an activation sensor, wherein the button cover is disposed within the aperture of the faceplate, the button cover is depressible, and the activation sensor is configured to generate an activation signal in response to detecting depression of the button cover, and the button cover defines charging contact openings through which the charging contacts extend; and electrical conductors configured to conduct electricity from the charging contacts to the rechargeable battery.

This application claims the benefit of U.S. Provisional Patent Application 63/591,982, filed Oct. 20, 2023, the entire content of which is incorporated by reference.

### TECHNICAL FIELD

This disclosure relates to hearing instruments.

### BACKGROUND

Hearing instruments are devices designed to be worn on, in, or near one or more of a user's ears. Common types of hearing instruments include hearing assistance devices (e.g., “hearing aids”), earbuds, headphones, hearables, cochlear implants, and so on. In some examples, a hearing instrument may be implanted or integrated into a user. Some hearing instruments include additional features beyond environmental sound-amplification. For example, some modern hearing instruments include advanced audio processing for improved device functionality, controlling and programming the devices, and beamforming, and some can even communicate wirelessly with external devices including other hearing instruments (e.g., for streaming media).

### SUMMARY

This disclosure describes designs for hearing instruments. There are several challenges faced by designers of user controls for hearing instruments. For example, users of hearing aids, with impaired sight and sense of touch, want the user controls to be easily locatable in an intuitive location, large enough to properly identify by touch, and provide a clear response when the user control is activated. Moreover, charging contacts have a risk of recessing into the faceplate or the part that serves as the outer case due to adhesion properties of the faceplate material. Furthermore, many modern hearing instruments have rechargeable batteries. Charging contacts on the surface of a hearing instrument conduct electrical energy from a charging device to a rechargeable battery of the hearing instrument. Like other components of hearing instruments, the charging contacts occupy valuable space within the hearing instrument and on the surface of the hearing instrument.

This disclosure describes hearing instruments in which a push button assembly includes charging contacts. The push button assembly further includes a push button that may be located at or near a center of a faceplate of the hearing instrument instead of the side of the faceplate, and may allow for efficient locating of the push button by the user of the hearing device. In some examples, locating the push button to at or near the center of the faceplate may decrease the overall area of the device, which may reduce manufacturing complexity and may make space available for the hearing instruments to include other components. In some examples, reducing the number of components may allow for a smaller form factor, which may allow for less noticeable or more comfortable hearing instruments.

As described herein, a hearing instrument comprises a rechargeable battery and a faceplate defining an aperture. The hearing instrument also includes a push button assembly coupled to the faceplate, wherein the push button assembly includes charging contacts, a button cover, and an activation sensor. The button cover is disposed within the aperture of the faceplate, wherein the button cover is depressible, and the activation sensor is configured to generate an activation signal in response to detecting depression of the button cover. The hearing instrument also includes a button cover defining charging contact openings through which the charging contacts extend. The hearing instrument may further include electrical conductors configured to conduct electricity from the charging contacts to the rechargeable battery.

As described herein, in one example, a hearing instrument comprises a rechargeable battery; a faceplate defining an aperture; a push button assembly coupled to the faceplate, wherein the push button assembly includes charging contacts, a button cover, and an activation sensor, wherein the button cover is disposed within the aperture of the faceplate, the button cover is depressible, and the activation sensor is configured to generate an activation signal in response to detecting depression of the button cover, and the button cover defines charging contact openings through which the charging contacts extend; and electrical conductors configured to conduct electricity from the charging contacts to the rechargeable battery.

In another example, this disclosure describes a method of assembling a hearing instrument, the method comprising: assembling a push button assembly that includes charging contacts, a button cover, and an activation sensor, the button cover is depressible, and the activation sensor is configured to generate an activation signal in response to detecting depression of the button cover, and the button cover defines charging contact openings through which the charging contacts extend; attaching the push button assembly and one or more other components of the hearing instrument to a spine; connecting the spine to a faceplate, wherein when the spine is connected to the faceplate the button cover is disposed within an aperture of the faceplate; and connecting the faceplate to a shell of the hearing instrument.

The details of one or more techniques of the disclosure are set forth in the accompanying drawings and the description below. Other features, objects, and advantages of the techniques described in this disclosure will be apparent from the description, drawings, and claims.

### BRIEF DESCRIPTION OF DRAWINGS

FIG. 1 is a conceptual diagram illustrating an example system that includes one or more hearing instruments, in accordance with one or more techniques of this disclosure.

FIG. 2 is a block diagram illustrating example components of a hearing instrument, in accordance with one or more techniques of this disclosure.

FIG. 3 is a block diagram illustrating example components of a push button assembly, in accordance with one or more techniques of this disclosure.

FIG. 4 is a conceptual diagram illustrating example components of a hearing instrument with a centrally located push button and charge interface, in accordance with one or more techniques of this disclosure.

FIG. 5 is a conceptual diagram illustrating a cross-sectional view of example components of a hearing instrument with a centrally located push button and charge interface, in accordance with one or more techniques of this disclosure.

FIG. 6 is a flowchart illustrating an example operation for assembling a hearing instrument in accordance with one or more techniques of this disclosure.

### DETAILED DESCRIPTION

Hearing instruments with user controls that are intuitively located are becoming increasingly important to users who may have impaired sight and/or sense of touch. A hearing instrument may have user-friendly push buttons to enhance the usability and effectiveness of the hearing instrument. The location of user controls such as push buttons is also important to ensure the controls do not interfere with other components on the hearing instrument.

User controls like push buttons are an important part of hearing instruments such as hearing aids. Due to the small sizes of hearing instruments, designing user controls that do not interfere with other components is challenging. This is especially the case with respect to completely-in-canal (CIC) hearing instruments, In-The-Canal (ITC) hearing instruments, In-The-Ear (ITE) hearing instruments, and Invisible-In-The-Canal (IIC) hearing instruments. Because such hearing instruments are compact in size and may be fully located inside a user's ear or ear canal, push buttons may be located close to the ear, making it difficult to depress the push buttons.

Many hearing instruments include rechargeable batteries that are enclosed within housings of the hearing instruments. Two or more charging contacts on an exterior surface of a housing of a hearing instrument may have a risk of recessing into the faceplate or the part that serves as the outer case due to mechanical inaccuracy of the faceplate aperture for the charging contacts. The charging contacts and associated conductors occupy valuable space on the exterior surface of the housing of the hearing instrument and within the housing of the hearing instrument.

This disclosure describes techniques that may address these issues. As described herein, the hearing instrument includes a rechargeable battery. The hearing instrument also includes electrical conductors configured to conduct electricity from the charging contacts to the rechargeable battery. Additionally, the hearing instrument includes a faceplate defining an aperture and a push button assembly coupled to the faceplate. The push button assembly also includes charging contacts, a button cover, and a button activation sensor. The button cover may be disposed within the aperture of the faceplate. The button cover is depressible by a user to provide input to the hearing instrument. In accordance with techniques of this disclosure, the button cover defines charging contact openings through which the charging contacts extend. The button activation sensor detects when the button cover is depressed. Because the push button assembly is disposed within the aperture of the faceplate and the push button assembly also includes charging contacts, the number of components in the hearing instrument, the form factor of the hearing instrument, and/or the complexity of manufacturing the hearing instrument may be reduced. Additionally, because the push button is located at the center of the faceplate and not on the side of the faceplate, the protrusion of the hearing instrument may be decreased which creates a rounder profile making the hearing instrument more discrete and substantially matches the geometry of the user's car. The push button assembly may also provide an improved user experience by providing a larger push button and a tactile response to the button actuator.

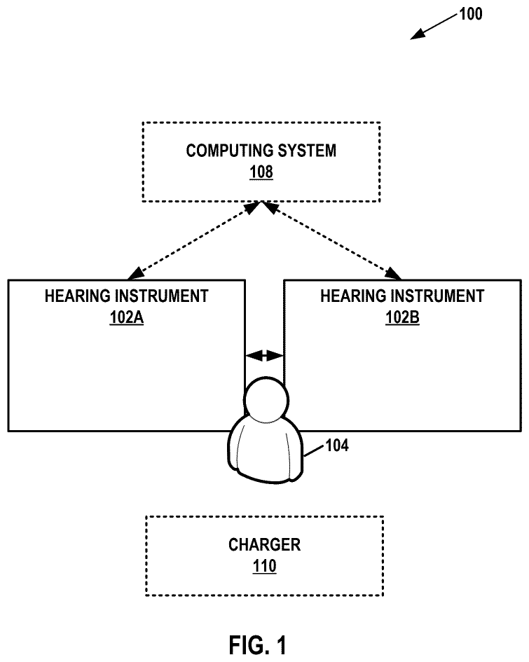

FIG. 1 is a conceptual diagram illustrating an example system 100 that includes hearing instruments 102A, 102B, in accordance with one or more techniques of this disclosure. This disclosure may refer to hearing instruments 102A and 102B collectively, as “hearing instruments 102.” A user 104 may wear hearing instruments 102. In some instances, user 104 may wear a single hearing instrument. In other instances, user 104 may wear two hearing instruments, with one hearing instrument for each car of user 104.

Hearing instruments 102 may comprise one or more of various types of devices that are configured to provide auditory stimuli to a user and that are designed for wear and/or implantation at, on, or near an car of the user. Hearing instruments 102 may be worn, at least partially, in the car canal or concha. One or more of hearing instruments 102 may include behind the car (BTE) components that are worn behind the cars of user 104. In some examples, one or more of hearing instruments 102 are able to provide auditory stimuli to user 104 via a bone conduction pathway.

In any of the examples of this disclosure, each of hearing instruments 102 may comprise a hearing assistance device. Hearing assistance devices include devices that help a user hear sounds in the user's environment. Example types of hearing assistance devices may include hearing aid devices, Personal Sound Amplification Products (PSAPs), cochlear implant systems (which may include cochlear implant magnets, cochlear implant transducers, and cochlear implant processors), and so on. In some examples, hearing instruments 102 are over-the-counter, direct-to-consumer, or prescription devices. Furthermore, in some examples, hearing instruments 102 include devices that provide auditory stimuli to the user that correspond to artificial sounds or sounds that are not naturally in the user's environment, such as recorded music, computer-generated sounds, or other types of sounds. For instance, hearing instruments 102 may include so-called “hearables,” earbuds, earphones, or other types of devices. Some types of hearing instruments provide auditory stimuli to the user corresponding to sounds from the user's environmental and also artificial sounds.

In some examples, one or more of hearing instruments 102 includes a housing that is designed to be worn in the car for both aesthetic and functional reasons and encloses the electronic components of the hearing instrument. Such hearing instruments may be referred to as ITE, ITC, CIC, or IIC devices. In some examples, one or more of hearing instruments 102 may be behind-the-car (BTE) devices, which include a housing worn behind the car that contains all of the electronic components of the hearing instrument, including the receiver (i.e., the speaker). The receiver conducts sound to an earbud inside the car via an audio tube. In some examples, one or more of hearing instruments 102 may be receiver-in-canal (RIC) hearing-assistance devices, which include a housing worn behind the car that contains electronic components and a housing worn in the car canal that contains the receiver.

Hearing instruments 102 may implement a variety of features that help user 104 hear better. For example, hearing instruments 102 may amplify the intensity of incoming sound, amplify the intensity of certain frequencies of the incoming sound, or translate or compress frequencies of the incoming sound. In another example, hearing instruments 102 may implement a directional processing mode in which hearing instruments 102 selectively amplify sound originating from a particular direction (e.g., to the front of the user) while potentially fully or partially canceling sound originating from other directions. In other words, a directional processing mode may selectively attenuate off-axis unwanted sounds. The directional processing mode may help users understand conversations occurring in crowds or other noisy environments. In some examples, hearing instruments 102 may use beamforming or directional processing cues to implement or augment directional processing modes. In some examples, hearing instruments 102 may reduce noise by canceling out or attenuating certain frequencies. Furthermore, in some examples, hearing instruments 102 may help user 104 enjoy audio media, such as music or sound components of visual media, by outputting sound based on audio data wirelessly transmitted to hearing instruments 102.

Hearing instruments 102 may be configured to communicate with each other. For instance, in any of the examples of this disclosure, hearing instruments 102 may communicate with each other using one or more wirelessly communication technologies. Example types of wireless communication technology include Near-Field Magnetic Induction (NFMI) technology, a 2.4 GHz technology, a BLUETOOTH™ technology, a WI-FI TM technology, audible sound signals, ultrasonic communication technology, infrared communication technology, an inductive communication technology, or another type of communication that does not rely on wires to transmit signals between devices. In some examples, hearing instruments 102 use a 2.4 GHz frequency band for wireless communication. In some examples of this disclosure, hearing instruments 102 may communicate with each other via non-wireless communication links (e.g., in addition to wireless communication links), such as via one or more cables, direct electrical contacts, and so on.

As shown in the example of FIG. 1, system 100 may also include a computing system 108. In other examples, system 100 does not include computing system 108. Computing system 108 comprises one or more computing devices, each of which may include one or more processors. For instance, computing system 108 may comprise one or more mobile devices, server devices, personal computer devices, handheld devices, wireless access points, smart speaker devices, smart televisions, medical alarm devices, smart key fobs, smartwatches, smartphones, motion or presence sensor devices, smart displays, screen-enhanced smart speakers, wireless routers, wireless communication hubs, prosthetic devices, mobility devices, special-purpose devices, accessory devices, and/or other types of devices. Accessory devices may include devices that are configured specifically for use with hearing instruments 102. Example types of accessory devices may include charging cases for hearing instruments 102, storage cases for hearing instruments 102, media streamer devices, phone streamer devices, external microphone devices, remote controls for hearing instruments 102, and other types of devices specifically designed for use with hearing instruments 102. One or more of hearing instruments 102 may communicate with computing system 108 using wireless or non-wireless communication links. For instance, hearing instruments 102 may communicate with computing system 108 and/or each other using any of the example types of communication technologies described elsewhere in this disclosure.

Furthermore, in the example of FIG. 1, system 100 may include a charger 110. Charger 110 is a device configured to recharge rechargeable batteries of hearing instruments 102. In some examples, charger 110 is a charging case. Charger 110 includes one or more pairs of charging terminals. Each pair of charging terminals is configured to interface with corresponding charging contacts of hearing instruments 102 that conduct electricity from charger 110 to a rechargeable battery of one of hearing instruments 102.

In accordance with the techniques of this disclosure, one or more of hearing instruments 102 includes a rechargeable battery and a faceplate defining an aperture. Each of hearing instruments 102 may include a push button assembly disposed within the aperture of the faceplate. The push button assembly includes charging contacts and a button cover that defines charging contact openings through which the charging contacts extend. Hearing instruments 102 may also include electrical conductors configured to conduct electricity from the charging contacts to the rechargeable battery.

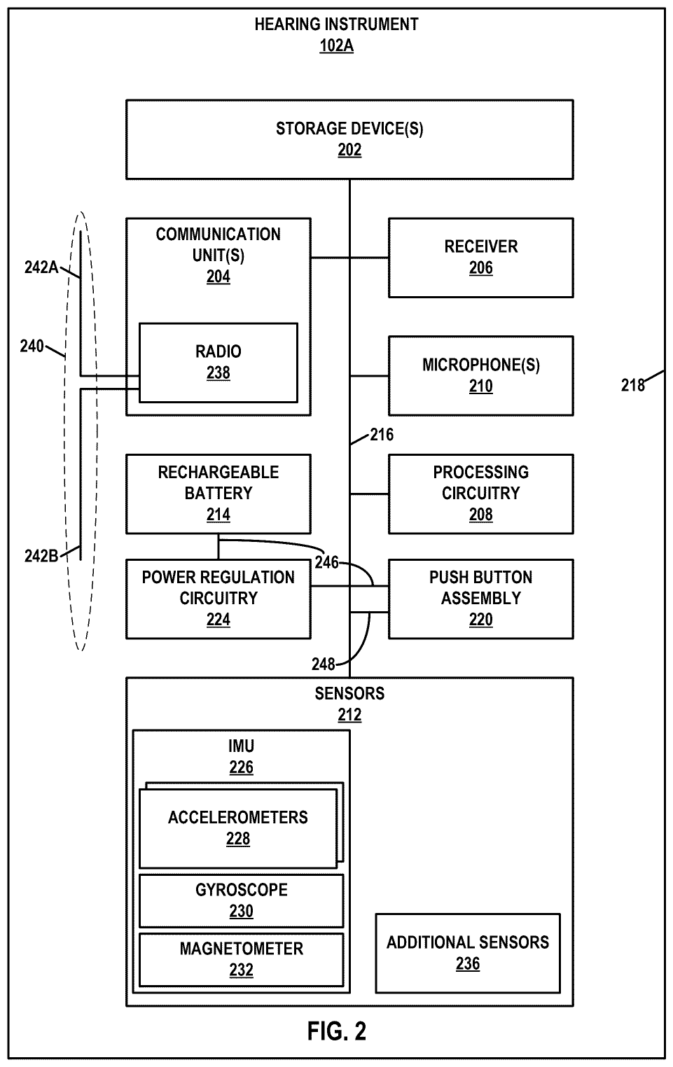

FIG. 2 is a block diagram illustrating example components of hearing instrument 102A, in accordance with one or more techniques of this disclosure. Although FIG. 2 and the other remaining figures are described with respect to hearing instrument 102A, hearing instrument 102B may be implemented in the same manner hearing instrument 102A.

In the example of FIG. 2, hearing instrument 102A comprises one or more storage devices 202, one or more communication units 204, a receiver 206, one or more processing circuitry 208, one or more microphones 210, a set of sensors 212, a rechargeable battery 214, and one or more communication channels 216. Communication channels 216 provide communication between storage devices 202, communication units 204, receiver 206, processing circuitry 208, microphones 210, sensors 212, push button assembly 220, and power regulation circuitry 224. Components 202, 204, 206, 208, 210, and 212 may draw electrical power from rechargeable battery 214. In the example of FIG. 2, each of components 202, 204, 206, 208, 210, 212, 214, 216, 220, and 224 may be contained within a single housing 218.

Furthermore, in the example of FIG. 2, sensors 212 include an inertial measurement unit (IMU) 226 that is configured to generate data regarding the motion of hearing instrument 102A. IMU 226 may include a set of sensors. For instance, in the example of FIG. 2, IMU 226 includes one or more of accelerometers 228, a gyroscope 230, a magnetometer 232, combinations thereof, and/or other sensors for determining the motion of hearing instrument 102A. Furthermore, in the example of FIG. 2, hearing instrument 102A may include one or more additional sensors 236. Additional sensors 236 may include a photoplethysmography (PPG) sensor, blood oximetry sensors, blood pressure sensors, electrocardiogramansors, body temperature sensors, electroencephalography (EEG) sensors, environmental temperature sensors, environmental pressure sensors, environmental humidity sensors, skin galvanic response sensors, and/or other types of sensors. In other examples, hearing instrument 102A and sensors 212 may include more, fewer, or different components.

Storage devices 202 may store data. Storage devices 202 may comprise volatile memory and may therefore not retain stored contents if powered off. Examples of volatile memories may include random access memories (RAM), dynamic random access memories (DRAM), static random access memories (SRAM), and other forms of volatile memories known in the art. Storage devices 202 may further be configured for long-term storage of information as non-volatile memory space and retain information after power on/off cycles. Examples of non-volatile memory configurations may include magnetic hard discs, optical discs, floppy discs, flash memories, or forms of electrically programmable memories (EPROM) or electrically erasable and programmable (EEPROM) memories.

Communication units 204 may enable hearing instrument 102A to send data to and receive data from one or more other devices, such as another hearing instrument, an accessory device, a mobile device, or another types of devices. Communication units 204 may enable hearing instrument 102A using wireless or non-wireless communication technologies. For instance, communication units 204 enable hearing instrument 102A to communicate using one or more of various types of wireless technology, such as a BLUETOOTH™ technology, 3G, 4G, 4G LTE, 5G, ZigBee, WI-FI™, Near-Field Magnetic Induction (NFMI), ultrasonic communication, infrared (IR) communication, or another wireless communication technology. In some examples, communication units 204 may enable hearing instrument 102A to communicate using a cable-based technology, such as a Universal Serial Bus (USB) technology.

As shown in the example of FIG. 2, communication units 204 include a radio 238. Radio 238 includes electronic components for generating and receiving electrical signals from an antenna 240. Antenna 240 may be implemented in accordance with any of the example antenna designs described in this disclosure. In the example of FIG. 2, antenna 240 includes a conductor 242A (e.g., a first conductor) and a conductor 242B (e.g., a second conductor) on an exterior surface of housing 218 and/or inside an internal cavity defined by housing 218. This disclosure may refer to conductor 242A and conductor 242B collectively as “conductors 242.” Antenna 240 may be a dipole antenna, conductor 242A and conductor 242B may be a first arm and a second part of the dipole antenna. In other examples, antenna 240 may be a monopole antenna, patch antenna, planar inverted-F antenna (PIFA) antenna, or another type of antenna.

Receiver 206 comprises one or more speakers for generating audible sound. Microphones 210 detects incoming sound and generates one or more electrical signals (e.g., an analog or digital electrical signal) representing the incoming sound.

Processing circuitry 208 may be processing circuits configured to perform various activities. For example, processing circuitry 208 may process audio signals generated by microphones 210, e.g., to enhance, amplify, or cancel-out particular channels within the incoming sound. Processing circuitry 208 may then cause receiver 206 to generate sound based on the processed signal. In some examples, processing circuitry 208 include one or more digital signal processors (DSPs). In some examples, processing circuitry 208 may cause communication units 204 to transmit (e.g., via radio 238 and antenna 240) one or more of various types of data. For example, processing circuitry 208 may cause communication units 204 to transmit data to computing system 108. Furthermore, communication units 204 may receive audio data from computing system 108 and processing circuitry 208 may cause receiver 206 to output sound based on the audio data.

Push button assembly 220 includes charging contacts, a button cover, and an activation sensor. The button cover is depressible, and the activation sensor is configured to generate an activation signal in response to detecting depression of the button cover. The button cover defines charging contact openings through which the charging contacts extend. Electrical conductors 246 may be configured to conduct electricity from the charging contacts of push button assembly to rechargeable battery 214, e.g., by way of power regulation circuitry 224. Additionally, one or more electrical conductors 248 may be configured to transmit the activation signals to processing circuitry 208.

Power regulation circuitry 224 may electrically connect rechargeable battery 214 and the charging contacts of push button assembly 220 via electrical conductors 246. Power regulation circuitry 224 may provide electrical connections between charging contacts and components within hearing instruments 102 and the cathode and the anode of rechargeable battery 214. For example, power regulation circuitry 224 may electrically connect the charging contacts to rechargeable battery 214 to facilitate charging of rechargeable battery 214. Power regulation circuitry 224 may also include circuitry, such as one or more processors, transistors, resistors, capacitors, etc., configured to monitor and regulate rechargeable battery 214. Power regulation circuitry 224 may monitor and regulate the storage capacity of rechargeable battery 214, energy storage levels of rechargeable battery 214, the voltage and/or amperage of energy received by rechargeable battery 214 and/or transmitted by rechargeable battery 214 (e.g., to components of hearing instrument 102A), or the like. Power regulation circuitry 224 may monitor rechargeable battery 214 by monitoring current energy storage levels of rechargeable battery 214 and/or rate(s) of increase or decrease of the current energy storage levels. Power regulation circuitry 224 may control the voltage and/or amperage of energy received by rechargeable battery 214 and/or transmitted by rechargeable battery 214, e.g., to facilitate proper charging and function of rechargeable battery 214 and/or to inhibit damage to components within hearing instrument 102A. Power regulation circuitry 224 may draw power from rechargeable battery 214 to perform one or more of the functions discussed above. In some examples, power regulation circuitry 224 is included in push button assembly 220.

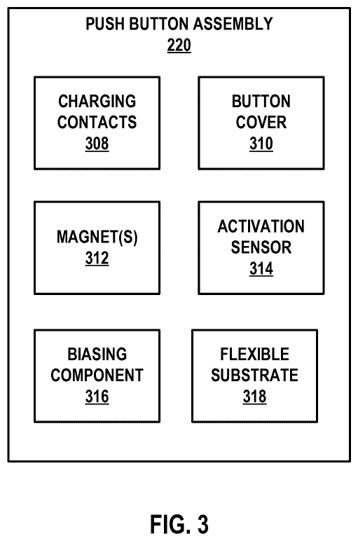

FIG. 3 is a block diagram illustrating example components of push button assembly 220, in accordance with one or more techniques of this disclosure. In the example of FIG. 3, push button assembly 220 includes charging contacts 308, button cover 310, magnet(s) 312, and an activation sensor 314. In other examples, push button assembly 220 may include more, fewer, or different components.

Charging contacts 308, which may also be known as charging pins or charging connectors, may be configured to facilitate the transfer of electrical power from an external power source (e.g., a charger 110) to rechargeable battery 214. Charging contacts 308 may make a direct connection to a charger (e.g., charger 110 of FIG. 1) allowing current to flow to rechargeable battery 214 (e.g., via electrical conductors 246 and power regulation circuitry 224) which may make for a size efficient method of charging.

Button cover 310 may be centrally located on a faceplate of hearing instrument 102A. Button cover 310 may define charging contact openings through which the charging contact 308 extend. Button cover 310 may be of a material and construction that prevent charging contacts 308 recessing into a shell of hearing instrument 102A. Button cover 310 may protect a charge flex (e.g., a flexible substrate carrying electrical conductors 246), prevent ingress of debris (e.g., dust, carwax, liquids, etc.) into hearing instrument 102A, serve as the cosmetic surface, and may provide a large surface area for the user to make direct contact. For instance, a size of an external surface of button cover 310 may be at least 20%, 30%, or another value of a size of an external surface of the faceplate. In some examples, a size of the external surface of button cover 310 has a diameter of at least 4-millimeters (mm) or at least 12.5 mm². Button cover 310 may match with the aperture of the faceplate of the hearing instrument. A flexible gasket may help prevent ingress of debris inside the hearing instruments 102 between the faceplate and button cover 310.

Magnet(s) 312 may be disposed behind button cover 310 and may be configured to attract corresponding elements of a charging device. Magnet(s) 312 may be configured to move with button cover 310 when button cover 310 is depressed. In some examples, magnet(s) 312 may directly press onto activation sensor 314 making mechanical actuation. In some examples, magnet(s) 312 may align charging contacts 308 to charger 110.

Activation sensor 314 may be mounted to a main circuit flex (e.g., a flexible substrate to which circuitry (e.g., power regulation circuitry 224 or other circuitry) or a secondary flex (e.g., another flexible substrate). Activation sensor 314 may also be connected to a spine of hearing instrument 102A. The spine of hearing instrument 102A may physically support internal components of hearing instrument 102A, such as one or more of communication units 204, receiver 206, processing circuitry 208, microphones 210, sensors 212, or rechargeable battery 214. Activation sensor 314 is further configured to generate an activation signal in response to detecting depression of button cover 310.

In some examples, a component of hearing instrument 102A (or, in some examples, push button assembly 220 of hearing instrument 102A) may be configured to provide tactile feedback when button cover 310 is depressed to help confirm to user 104 of hearing instrument 102A that hearing instrument 102A has registered that the button has been actuated. For example, hearing instrument 102A may include a vibration unit that vibrates when activation sensor 314 detects that button cover 310 has been depressed. In some examples, processing circuitry 208 may cause receiver 206 to output a sound when activation sensor 314 detects that button cover 310 has been depressed. In some examples, hearing instrument 102A includes a mechanical element that produces a clicking sound when button cover 310 has been sufficiently depressed for activation sensor 314 to register depression of button cover 310. In some examples, hearing instrument 102A includes a mechanical element that resists depression of button cover 310 until sufficient force is applied to button cover 310 to allow activation sensor 314 to register depression of button cover 310.

In some examples, push button assembly 220 includes a biasing component 316 that physically pushes button cover 310 (and potentially other components of push button assembly 220) toward an outer surface of the faceplate. In some examples, biasing component 316 includes a spring. In some examples, biasing component 316 includes a flexible dome.

In some examples, an adhesive holds together two or more components of push button assembly 220. For instance, the adhesive may hold together charging contacts 308, button cover 310, magnets 312, and/or other components of push button assembly 220 such that the adhered components move together as a group.

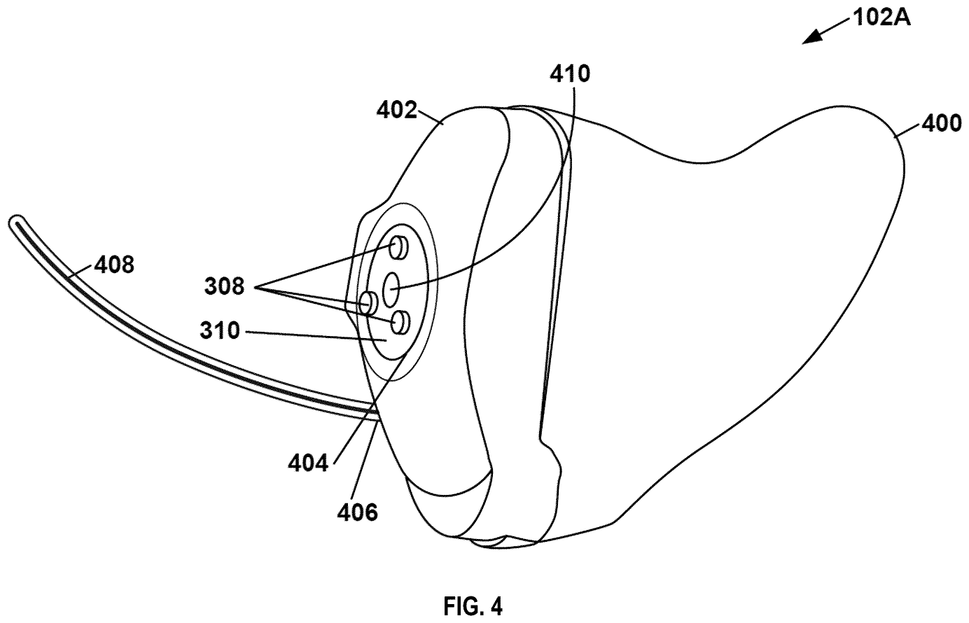

Furthermore, in the example of FIG. 4, push button assembly 220 may include a flexible substrate 318 on which electrical conductors 246 are disposed. Flexible substrate 318 may be disposed between interior surfaces of charging contacts 308 and magnet(s) 312. In some examples, power regulation circuitry 224 is disposed on flexible substrate 318. As discussed above, power regulation circuitry 224 may electrically connect rechargeable battery 214 to charging contacts 308 via electrical conductors 246 to regulate a flow of electricity during charging of rechargeable battery 214.

FIG. 4 is a conceptual diagram illustrating example components of hearing instrument 102A with a centrally located push button and charge interface, in accordance with one or more techniques of this disclosure. In the example of FIG. 4, housing 218 of hearing instrument 102A includes a shell 400 and a faceplate 402.

Shell 400, which may also be known as the outer casing or housing, may protect internal components from physical damage, moisture and dust as well as contribute to the user's comfort and effectiveness of device. Shell 400 may further contain openings for microphones, speakers, and controls. Shell 400 may be of various styles and materials like acrylic, silicone, or a combination of materials.

Faceplate 402 may have a slight increase in thickness in the center to create a rounder profile of hearing instruments 102. Faceplate 402 may correspond to geometry of car of the user to create a more discreet appearance. For instance, faceplate 402 may have a rounded profile to correspond to or otherwise fit a geometry of the car.

Faceplate 402 may include features like an antenna, microphone opening and charging interface on the exterior. Push button assembly 220 components are position on top of faceplate 402 so prevent the push button from making contact with the car when depressed and making the area and the protrusion of faceplate 402 lessened. Push button assembly 220 is coupled to faceplate 402. In some examples, push button assembly 220 may be disposed within the aperture 404 of the faceplate 402 which may cause faceplate 402 to act as the interface between the push button assembly 220 components and shell 400.

Faceplate 402 defines an aperture 404 in which button cover 310 of push button assembly 220 is disposed. Additionally, in the example of FIG. 4, faceplate 402 defines an aperture 406 through which an antenna element 408 extends. Antenna element 408 may be a radiating element of antenna 240, such as one of conductors 242.

As shown in the example of FIG. 4, button cover 310 defines openings through which charging contacts 308 extend. Furthermore, in the example of FIG. 4, button cover 310 defines an opening through which a centering element 410 extends. Centering element 410 include a concave surface configured to interface with a corresponding convex surface of an element of charger 110 to help maintain a position of charging contacts 308 relative to corresponding charging contacts of charger 110 during charging of rechargeable battery 214.

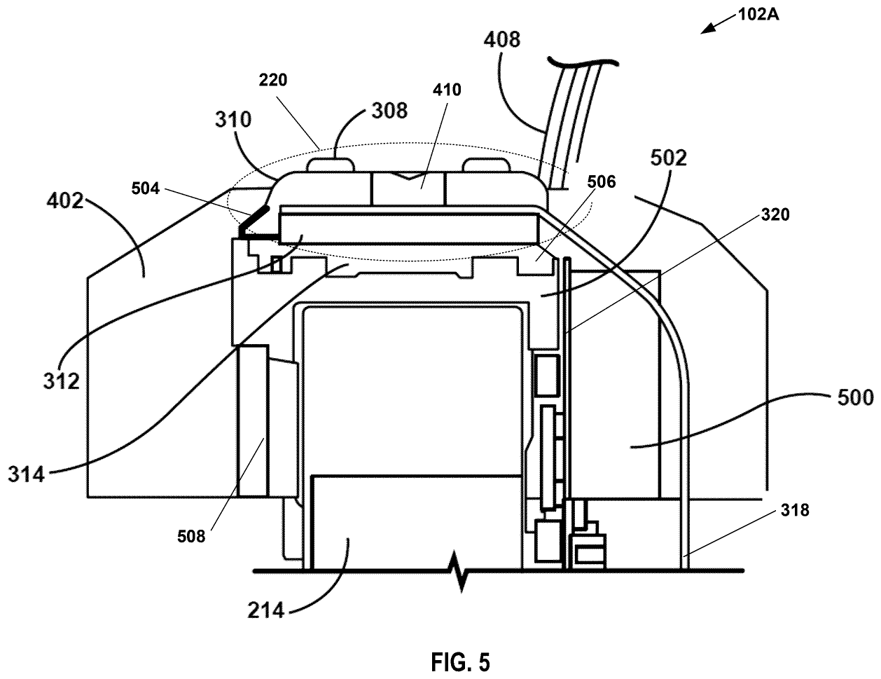

FIG. 5 is a conceptual diagram illustrating a cross-sectional view of example components of hearing instrument 102A with a centrally located push button and charge interface, in accordance with one or more techniques of this disclosure. In the example of FIG. 5, push button assembly 220 of hearing instrument 102A includes charging contacts 308, button cover 310, magnet(s) 312, and activation sensor 314. Additionally, hearing instrument 102A includes faceplate 402, spine 502, antenna element 408, a circuit 500 and rechargeable battery 214. When user 104 depresses button cover 310, charging contacts 308, button cover 310, and magnets 312 may temporarily recede into a void 506.

Spine 502 may support circuit 500 (including processing circuitry 208), rechargeable battery 214, and potentially other components of hearing instrument 102A. Circuit 500 may include processing circuitry 208 (FIG. 2). Spine 502 may be connected to faceplate 402. For instance, spine 502 may be connected to faceplate 402 through mechanical attachment methods or adhesives which may prevent push button assembly 220 from shifting around and remain in position in housing 218 of hearing instrument 102A. In the example of FIG. 5, spine 502 supports activation sensor 314, thus helping to ensure the positioning of push button assembly 220.

Charging contacts 308 may make a direct connection to charger 110 allowing current to flow to circuit 500 and rechargeable battery 214. Charging contacts 308 may be small metal points or connectors configured to facilitate the recharging of rechargeable battery 214. Because charging contacts facilitate recharging of rechargeable battery 214, charging contacts 308 may eliminate the need for disposable batteries and may provide a means for recharging hearing instrument 102A. Magnet(s) 312 may be configured to align and maintain contact between charging contacts 308 and charger. Magnet(s) 312 may further be configured to directly press onto activation sensor 314 making mechanical actuation.

A contour of button cover 310 may match aperture 404 of faceplate 402. A flexible gasket 504 disposed between button cover 310 and faceplate 402 may help prevent ingress of debris into an interior cavity of hearing instrument 102A. Gasket 504 may be in a compressed state when button cover 310 is not depressed and in an expanded state when button cover 310 is depressed. In the example of FIG. 5, gasket 504 is shown in the compressed state. Regardless of whether gasket 504 is in the compressed state or the expanded state, gasket 504 may occupy a space between faceplate 402 and button cover 310, thereby preventing ingress of debris into an interior cavity 508 of hearing instrument 102A.

In earlier hearing instruments that have charging contacts disposed on their faceplates, the charging contacts may recede toward the interior cavities of the hearing instruments when an adhesive bond between the charging contacts and the faceplates breaks. When the charging contacts recede toward the interior cavities of the hearing instruments, the charging contacts may no longer be able to make sufficient contact with corresponding charging contacts of a charger, thereby preventing recharging of rechargeable batteries of the hearing instruments.

However, in accordance with techniques of this disclosure, charging contacts 308 may be physically supported by other physical components of push button assembly 220, thus diminishing the chances of charging contacts 308 receding into interior cavity 508 of hearing instrument 102A. Button cover 310 may further be configured to protect the charge flex, prevent ingress of debris into hearing instrument 102A, serve as the cosmetic surface of hearing instrument 102A, and may provide a relatively large surface for the user of hearing instrument 102A to touch.

Faceplate 402 may be the visible exterior surface of hearing instruments 102. Faceplate 402 may have increased thickness in the center that may create a rounder profile of the hearing instrument which corresponds to the geometry of the user's ear while also creating a more discrete appearance.

Activation sensor 314 may be installed on the main or secondary circuit flex and is connected to the spine of hearing instruments 102. In the example of FIG. 5, hearing instrument 102A includes a flexible substrate 320 on which both processing circuitry 500 and activation sensor 314 are disposed. Activation sensor 314 may be configured to provide tactile feedback to user. In the example of FIG. 5, activation sensor 314 includes a flexible dome that may serve as biasing component 316 to push button cover 310 (as well as magnets 312, charging contacts 308, etc.) toward an outer surface of faceplate 402.

Circuit 500 of hearing instruments 102 may be configured to process incoming sounds, amplify and/or alter the sounds, and deliver the sound to the user of hearing instrument 102A. The circuit of hearing instruments 102 may include a microphone, sound processor, amplifier, volume control, wireless connectivity, power supply and other components and functions.

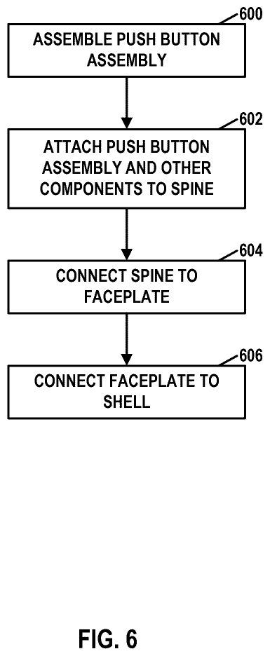

FIG. 6 is a flowchart illustrating an example operation for assembling hearing instrument 102A in accordance with one or more techniques of this disclosure. In the example of FIG. 6, one or more assemblers (e.g., one or more people, robots, machines, or combinations thereof) may assemble components (e.g., two or more charging contacts 308, button cover 310, magnet(s) 312, activation sensor 314, biasing component 316, flexible substrate 318, etc.) of push button assembly 220 (600). In some examples, the one or more assemblers may use an adhesive to connect the components of push button assembly 220.

The one or more assemblers may then attach push button assembly 220 and other components (e.g., communication units 204, receiver 206, processing circuitry 208, microphones 210, rechargeable battery 214, etc.) to spine 502 (602). In some examples, the one or more assemblers may attach push button assembly 220 and the other components to spine 502 at predefined positions, recesses, or openings defined in spine 502. In some examples, the one or more assemblers may position one or more magnets 312 behind button cover 310. Furthermore, in some examples, the one or more assemblers may dispose gasket 504 between button cover 310 and faceplate 402 to prevent ingress of debris into an interior cavity of hearing instrument 102A.

The one or more assemblers may connect spine 502 to faceplate 402 (604). In some examples, the one or more assemblers may connect spine 502 to faceplate 402 after attaching push button assembly 220 and the other components to spine 502. In other examples, the one or more assemblers may connect spine 502 to faceplate 402 before attaching push button assembly 220 and the other components to spine 502. Mechanical components, such as slots, flanges, fasteners, adhesives, etc. may be used to attach spine 502 to faceplate 402.

After spine 502 is connected to faceplate 402 and push button assembly 220 and the other components are connected to spine 502, the one or more assemblers may connect faceplate 402 to shell 400 (606). In some examples, an adhesive may be used to connect faceplate 402 to shell 400. In some examples, faceplate 402 may be removably connected to shell 400. In some examples, the one or more assemblers may shape faceplate 402 to have a profile that corresponds to a geometry of an car of a user, e.g., by trimming, cutting, polishing, or otherwise shaping faceplate 402.

The following is a non-limiting list of clauses in accordance with techniques of this disclosure.

Clause 1. A hearing instrument comprising: a rechargeable battery; a faceplate defining an aperture; a push button assembly coupled to the faceplate, wherein the push button assembly includes charging contacts, a button cover, and an activation sensor, wherein the button cover is disposed within the aperture of the faceplate, the button cover is depressible, and the activation sensor is configured to generate an activation signal in response to detecting depression of the button cover, and the button cover defines charging contact openings through which the charging contacts extend; and electrical conductors configured to conduct electricity from the charging contacts to the rechargeable battery.

Clause 2. The hearing instrument of clause 1, wherein the push button assembly comprises one or more magnets disposed behind the button cover and configured to attract one or more corresponding charging contacts of a charger.

Clause 3. The hearing instrument of clause 2, wherein the one or more magnets are configured to move with the button cover when the button cover is depressed.

Clause 4. The hearing instrument of any of clauses 2-3, wherein an adhesive holds together the charging contacts, the button cover, and the one or more magnets.

Clause 5. The hearing instrument of any of clauses 2-4, further comprising a flexible substrate on which the electrical conductors are disposed, wherein the flexible substrate is disposed between interior surfaces of the charging contacts and the one or more magnets.

Clause 6. The hearing instrument of clause 5, wherein: the hearing instrument further comprises power regulation circuitry that electrically connects the rechargeable battery to the charging contacts via the electrical conductors to regulate a flow of the electricity during charging of the rechargeable battery, and the power regulation circuitry is disposed on the flexible substrate.

Clause 7. The hearing instrument of any of clauses 1-6, further comprising: processing circuitry configured to process audio signals generated by microphones of the hearing instrument; and a spine that supports the push button assembly, the rechargeable battery, and the processing circuitry, wherein the spine is connected to the faceplate.

Clause 8. The hearing instrument of clause 7, further comprising a flexible substrate on which both the processing circuitry and the activation sensor are disposed.

Clause 9. The hearing instrument of any of clauses 1-8, wherein a size of an external surface of the button cover is at least 20% of a size of an external surface of the faceplate.

Clause 10. The hearing instrument of any of clauses 1-9, wherein a size of an external surface of the button cover has a diameter of at least 4-millimeters (mm) or at least 12.5 mm².

Clause 11. The hearing instrument of any of clauses 1-10, wherein a biasing component of the push button assembly physically pushes the button cover toward an outer surface of the faceplate.

Clause 12. The hearing instrument of any of clauses 1-11, wherein the push button assembly comprises a centering element that includes a concave surface configured to interface with a corresponding convex surface of an element of a charger to help maintain a position of the charging contacts relative to corresponding charging contacts of the charger during charging of the rechargeable battery.

Clause 13. The hearing instrument of any of clauses 1-12, wherein the faceplate has a rounded profile to correspond to a geometry of an car of a user.

Clause 14. The hearing instrument of any of clauses 1-13, wherein a component of the push button assembly provides tactile feedback when the button cover is depressed.

Clause 15. The hearing instrument of any of clauses 1-14, wherein the push button assembly further comprises a gasket disposed between the button cover and the faceplate to prevent ingress of debris into an interior cavity of the hearing instrument.

Clause 16. A method of assembling a hearing instrument, the method comprising: assembling a push button assembly that includes charging contacts, a button cover, and an activation sensor, the button cover is depressible, and the activation sensor is configured to generate an activation signal in response to detecting depression of the button cover, and the button cover defines charging contact openings through which the charging contacts extend; attaching the push button assembly and one or more other components of the hearing instrument to a spine; connecting the spine to a faceplate, wherein when the spine is connected to the faceplate the button cover is disposed within an aperture of the faceplate; and connecting the faceplate to a shell of the hearing instrument.

Clause 17. The method of clause 16, wherein assembling the push button assembly comprises positioning one or more magnets behind the button cover.

Clause 18. The method of any of clauses 16-17, wherein a size of an external surface of the button cover is at least 20% of a size of an external surface of the faceplate.

Clause 19. The method of any of clauses 16-18, wherein the size of the external surface of the button cover has a diameter of at least 4-millimeters (mm) or at least 12.5 mm².

Clause 20. The method of any of clauses 16-19, wherein assembling the push button assembly comprises disposing a gasket between the button cover and the faceplate to prevent ingress of debris into an interior cavity of the hearing instrument.

Clause 21. The method of any of clauses 16-20, further comprising shaping the faceplate to have a profile that corresponds to a geometry of an car of a user.

In this disclosure, ordinal terms such as “first,” “second,” “third,” and so on, are not necessarily indicators of positions within an order, but rather may be used to distinguish different instances of the same thing. Examples provided in this disclosure may be used together, separately, or in various combinations. Furthermore, with respect to examples that involve personal data regarding a user, it may be required that such personal data only be used with the permission of the user.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processing circuits to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, cache memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Functionality described in this disclosure may be performed by fixed function and/or programmable processing circuitry. For instance, instructions may be executed by fixed function and/or programmable processing circuitry. Such processing circuitry may include one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements. Processing circuits may be coupled to other components in various ways. For example, a processing circuit may be coupled to other components via an internal device interconnect, a wired or wireless network connection, or another communication medium.

The techniques of this disclosure may be implemented in a wide variety of devices or apparatuses, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

What is claimed is:

1. A hearing instrument comprising:
a rechargeable battery;
a faceplate defining an aperture;
a push button assembly coupled to the faceplate, wherein the push button assembly includes charging contacts, a button cover, and an activation sensor, wherein the button cover is disposed within the aperture of the faceplate, the button cover is depressible, and the activation sensor is configured to generate an activation signal in response to detecting depression of the button cover, and the button cover defines charging contact openings through which the charging contacts extend; and
electrical conductors configured to conduct electricity from the charging contacts to the rechargeable battery.

2. The hearing instrument of claim 1, wherein the push button assembly comprises one or more magnets disposed behind the button cover and configured to attract one or more corresponding charging contacts of a charger.

3. The hearing instrument of claim 2, wherein the one or more magnets are configured to move with the button cover when the button cover is depressed.

4. The hearing instrument of claim 2, wherein an adhesive holds together the charging contacts, the button cover, and the one or more magnets.

5. The hearing instrument of claim 2, further comprising a flexible substrate on which the electrical conductors are disposed, wherein the flexible substrate is disposed between interior surfaces of the charging contacts and the one or more magnets.

6. The hearing instrument of claim 5, wherein:
the hearing instrument further comprises power regulation circuitry that electrically connects the rechargeable battery to the charging contacts via the electrical conductors to regulate a flow of the electricity during charging of the rechargeable battery, and
the power regulation circuitry is disposed on the flexible substrate.

7. The hearing instrument of claim 1, further comprising:
processing circuitry configured to process audio signals generated by microphones of the hearing instrument; and
a spine that supports the push button assembly, the rechargeable battery, and the processing circuitry, wherein the spine is connected to the faceplate.

8. The hearing instrument of claim 7, further comprising a flexible substrate on which both the processing circuitry and the activation sensor are disposed.

9. The hearing instrument of claim 1, wherein a size of an external surface of the button cover is at least 20% of a size of an external surface of the faceplate.

10. The hearing instrument of claim 1, wherein a size of an external surface of the button cover has a diameter of at least 4-millimeters (mm) or at least 12.5 mm².

11. The hearing instrument of claim 1, wherein a biasing component of the push button assembly physically pushes the button cover toward an outer surface of the faceplate.

12. The hearing instrument of claim 1, wherein the push button assembly comprises a centering element that includes a concave surface configured to interface with a corresponding convex surface of an element of a charger to help maintain a position of the charging contacts relative to corresponding charging contacts of the charger during charging of the rechargeable battery.

13. The hearing instrument of claim 1, wherein the faceplate has a rounded profile to correspond to a geometry of an ear of a user.

14. The hearing instrument of claim 1, wherein a component of the push button assembly provides tactile feedback when the button cover is depressed.

15. The hearing instrument of claim 1, wherein the push button assembly further comprises a gasket disposed between the button cover and the faceplate to prevent ingress of debris into an interior cavity of the hearing instrument.

16. A method of assembling a hearing instrument, the method comprising:
assembling a push button assembly that includes charging contacts, a button cover, and an activation sensor, the button cover is depressible, and the activation sensor is configured to generate an activation signal in response to detecting depression of the button cover, and the button cover defines charging contact openings through which the charging contacts extend;
attaching the push button assembly and one or more other components of the hearing instrument to a spine;
connecting the spine to a faceplate, wherein when the spine is connected to the faceplate the button cover is disposed within an aperture of the faceplate; and
connecting the faceplate to a shell of the hearing instrument.

17. The method of claim 16, wherein assembling the push button assembly comprises positioning one or more magnets behind the button cover.

18. The method of claim 16, wherein at least one of:
a size of an external surface of the button cover is at least 20% of a size of an external surface of the faceplate, or
the size of the external surface of the button cover has a diameter of at least 4-millimeters (mm) or at least 12.5 mm².

19. The method of claim 16, wherein assembling the push button assembly comprises disposing a gasket between the button cover and the faceplate to prevent ingress of debris into an interior cavity of the hearing instrument.

20. The method of claim 16, further comprising shaping the faceplate to have a profile that corresponds to a geometry of an ear of a user.
